(19) United States
(12) Patent Application Publication
(10) Pub. No.: US 2019/0191219 A1
(43) Pub. Date: Jun. 20, 2019

(54) MANAGEMENT OF CONTENT SEGMENTS GENERATED BY AN AUTHORIZED SUBSCRIBER DEVICE FOR SHARING WITH NON-SUBSCRIBER DEVICES

(71) Applicant: SLING MEDIA L.L.C., Foster City, CA (US)

(72) Inventor: ADITYA KULKARNI, Foster City, CA (US)

(73) Assignee: SLING MEDIA L.L.C., Foster City, CA (US)

(21) Appl. No.: 15/847,241

(22) Filed: Dec. 19, 2017

(51) Int. Cl. H04N 21/4627; H04N 21/472

(52) U.S. Cl. CPC H04N 21/4627; H04N 21/47202

(57) ABSTRACT

Disclosed herein are methods and related systems to manage preview segments to be shared with non-subscriber presentation devices. An exemplary method maintains a preview segment generated from content available at an authorized subscriber device, and associates the segment with access parameters maintained at the server system. The parameters regulate and restrict access to the preview segment by non-subscriber presentation devices having restricted rights to directly view or access the source content. The server system receives an access request from a non-subscriber presentation device. The access request includes a preview identifier of the preview segment and a device identifier of the requesting device, a user identifier of a user of the requesting device, and/or a network address of the requesting device. The request is processed to determine access parameters for the preview segment applicable to the requesting device, and access is granted or denied based on the determined access parameters.

### TECHNICAL FIELD

Embodiments of the subject matter described herein relate generally to content delivery systems, such as a video services system. More particularly, embodiments of the subject matter relate to techniques, systems, and methodologies that allow an authorized subscriber device to share segments of content, such as short video clips, with non-subscriber devices.

### BACKGROUND

Most television viewers now receive their video signals through a content aggregator such as a cable or satellite television provider. Digital video broadcasting (DVB) systems, such as satellite systems, are generally known. A DVB system that delivers video service to a home will usually include a video services receiver, system, or device, which is commonly known as a set-top box (STB). In the typical instance, encoded television signals are sent via a cable or wireless data link to the viewer's home, where the signals are ultimately decoded in the STB. The decoded signals can then be viewed on a television or other appropriate display as desired by the viewer.

Digital content distribution, social media interaction, and content sharing have become routine aspects of daily life for millions of people. The medium of information transmission has long been a combination of text (books and newspapers), audio (speech and radio) and visuals (posters, images, movies, news footage). Traditional text-based information can be easily and repeatedly retransmitted and shared, thereby propagating the source of the content (pamphlets, excerpts from books, magazines, etc.). However, the same cannot be said about multimedia content, especially video content. This is usually due to a lack of resources of video information (compared to text), at least until recent times. It is also because of the failure to have a consistent and reliable method to provide such sharing and the ability to control the access to such shared content.

Visual messaging (using, for example, video content) is easier to convey, especially because there is less re-interpretation than text-based content. It is easier to predict the likely consumers of a certain visual content than textual content. Considering that video is now a very common mode of information sharing, this makes the usage of visual content well suited for re-distribution and endorsement of the content source.

Accordingly, it is desirable to have a quick, easy, and intuitive methodology for creating and sharing a short segment of audio or video content by an authorized subscriber device (e.g., a legitimate subscriber's satellite or cable television set-top box), wherein the segment of content is to be shared with a non-subscriber user/device that has no permission or rights to access the original source content. Furthermore, other desirable features and characteristics will become apparent from the subsequent detailed description and the appended claims, taken in conjunction with the accompanying drawings and the foregoing technical field and background.

### BRIEF SUMMARY

Disclosed herein is a method of managing preview segments of content to be shared with non-subscriber presentation devices. In accordance with exemplary embodiments, the method includes the steps of: maintaining, at a management server system, a preview segment generated from source content available at an authorized subscriber device; associating the preview segment with access parameters maintained at the management server system, the access parameters regulating and restricting access to the preview segment by non-subscriber presentation devices having restricted rights to directly view or access the source content; receiving, at the management server system, an access request generated by a requesting non-subscriber presentation device, the access request comprising a preview identifier of the preview segment and at least one of: a device identifier of the requesting non-subscriber presentation device, a user identifier of a user of the requesting non-subscriber presentation device, and a network address of the requesting non-subscriber presentation device; processing the access request at the management server system to determine access parameters for the preview segment applicable to the requesting non-subscriber presentation device; and granting or denying the requesting non-subscriber presentation device access to the preview segment, based on the determined access parameters.

Also disclosed is a computer-implemented content management server system having: a processor device; and a non-transitory computer readable medium operatively associated with the processor device, the computer readable medium storing executable instructions configurable to cause the processor device to perform a method of managing preview segments of content to be shared with presentation devices. Exemplary embodiments of the method involve the steps of: maintaining, at the content management server system, a preview segment generated from source content available at an authorized subscriber device; associating the preview segment with access parameters maintained at the content management server system, the access parameters regulating and restricting access to the preview segment by non-subscriber presentation devices having restricted rights to directly view or access the source content; receiving, at the content management server system, an access request generated by a requesting non-subscriber presentation device, the access request comprising a preview identifier of the preview segment and at least one of: a device identifier of the requesting non-subscriber presentation device, a user identifier of a user of the requesting non-subscriber presentation device, and a network address of the requesting non-subscriber presentation device; processing the access request at the content management server system to determine access parameters for the preview segment applicable to the requesting non-subscriber presentation device; and granting or denying the requesting non-subscriber presentation device access to the preview segment, based on the determined access parameters.

Also disclosed is a method of managing preview segments of content to be shared with non-subscriber presentation devices. Exemplary embodiments of the method involve the steps of: maintaining, at a management server system, access parameters in association with a preview segment generated from source content available at an authorized subscriber device, wherein the access parameters are utilized to regulate and restrict access to the preview segment by non-subscriber presentation devices having limited rights to directly view or access the source content; receiving, at the management server system, an access request generated by a requesting non-subscriber presentation device, the access request comprising a preview identifier of the preview segment and at least one of: a device identifier of the requesting non-subscriber presentation device, a user identifier of a user of the requesting non-subscriber presentation device, and a network address of the requesting non-sub scriber presentation device; processing the access request at the management server system to determine access parameters for the preview segment applicable to the requesting non-subscriber presentation device; and granting or denying the requesting non-subscriber presentation device access to the preview segment, based on the determined access parameters.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified block diagram that depicts an exemplary embodiment of a content sharing system;

FIG. 2 is a simplified block diagram representation of an exemplary embodiment of a computer-implemented device or system suitable for use with the content sharing system depicted in FIG. 1;

FIG. 3 is a flow chart that illustrates an exemplary embodiment of a method of managing preview segments of content to be shared with non-subscriber presentation devices; and

FIG. 4 is a flow chart that illustrates an alternate embodiment of the method depicted in FIG. 3.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like. The software that performs the described functionality may reside and execute at a host device, such as a video services receiver, a mobile device, or a home entertainment component, or it may be distributed for execution across a plurality of physically distinct devices, systems, or components, as appropriate for the particular embodiment.

The following description relates to a content delivery and management system that is suitably configured to process audio/visual content for presentation to a user. Although the following description focuses on video content provided by a video services system (such as a satellite delivery system, a cable delivery system, or a web-based delivery system), the subject matter may also be utilized to handle audio content conveyed in an audio stream, such as a broadcast radio program, a streaming music channel, or the like.

The exemplary embodiments described below relate to a video delivery system such as a satellite television system, a cable delivery system, an Internet-based streaming content delivery system, a cellular network delivery system, or the like. The disclosed subject matter relates to a system and related methodology for managing and regulating access to short segments of video content generated by an authorized and legitimate subscriber device, wherein the authorized subscriber device shares the content segments with non-subscriber presentation devices (that otherwise have limited, restricted, or no access rights or permission to view the original source content). More specifically, the methodology presented herein utilizes access parameters and access criteria to determine the extent by which a given segment of content (e.g., a short preview clip) can be shared with non-subscriber devices.

In accordance with a typical use case scenario, an authorized subscriber device may be the set-top box of legitimate customer of a video services system. Subscribers of a video services system can enjoy and consume a variety of content that is provided at a cost. Live television, on-demand video content, over the top television, pre-processed content, and the like can be provided by a video services system or network. Legitimate customers are authorized to use such content without redistribution rights, using some form of authentication. In accordance with most terms and conditions, video content delivered to consumers cannot be freely shared with “non-paying” (non-subscriber) users.

On the other hand, content providers and content owners work hard to advertise their content and to get more people to consume their content at a cost. If authorized users have their redistribution restrictions relaxed, they can share previews of the content they are consuming to a wider audience that might not otherwise have access to the content, thereby allowing a social network to reach the targeted audience and also enjoy the social experience of video content consumption. Sharing of content segments in this manner has certain benefits and advantages. For example, permitting shared preview clips can be a form of advertising that takes advantage of a targeted and focused social outreach (person-to-person sharing). The preview mechanism can act as a trailer feature or teaser to reach out to more potential customers, and the methodology propagates further at no additional cost to the content provider.

In accordance with the sharing mechanisms described in more detail below, preview content can be uploaded or delivered to a non-subscriber user by way of at least one of two mechanisms: to be stored on the non-subscriber presentation device using certain restrictions and regulations; or to be hosted through a social sharing infrastructure or a centralized content management server system using certain restrictions and regulations. the restrictions below.

The system presented here can implement certain rules, protections, and methodologies to prevent abuse of the content preview mechanism. For example, the sharing of content segments can be restricted or regulated using any one or more of the following access parameters, without limitation: maximum length of content for which a preview can be generated; maximum number of times a preview can be generated on a specific event/channel during a fixed period of time; time duration within which the preview content remains accessible to the non-subscriber user; number of times a non-subscriber user can watch a given segment of shared content; number of users who are allowed access to the preview content.

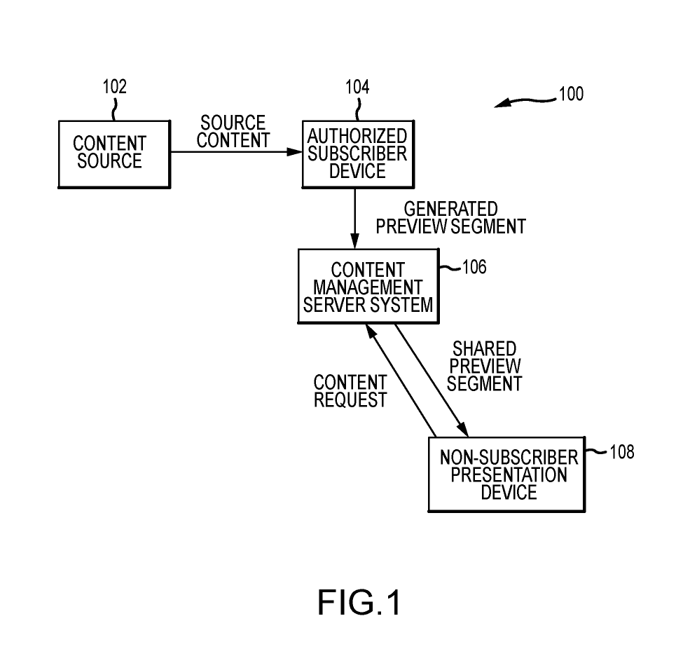

Referring now to the drawings, FIG. 1 is a simplified block diagram that depicts an exemplary embodiment of a content sharing system 100 that is suitably configured to support the techniques and methodologies described in more detail below. The system 100 (which has been simplified for purposes of illustration) generally includes, without limitation: at least one content source 102 (referred to in the singular form herein for the sake of convenience); an authorized subscriber device 104, which may be a video services receiver, a set-top box, or other form of customer equipment that is capable of receiving, processing, and rendering video content; a computer-implemented content management server system 106; and a non-subscriber presentation device 108. In certain embodiments, the content source 102, the authorized subscriber device 104, the management server system 106, and the non-subscriber presentation device 108 communicate using a data communication network (not separately shown in FIG. 1). For the sake of brevity, conventional techniques related to satellite, cable, and Internet-based communication systems, video broadcasting systems, data transmission, signaling, network control, and other functional aspects of the systems (and the individual operating components of the systems) may not be described in detail herein.

The data communication network utilized by the system can be any digital or other communications network capable of transmitting messages between senders and receivers. In various embodiments, the network includes any number of public or private data connections, links or networks supporting any number of communications protocols. The network may include the Internet, for example, or any other network based upon TCP/IP or other conventional protocols. In various embodiments, the network also incorporates a wireless and/or wired telephone network, such as a cellular communications network for communicating with mobile phones, personal digital assistants, and/or the like. The network may also incorporate any sort of wireless or wired local area networks, such as one or more IEEE 802.3 and/or IEEE 802.11 networks.

The system 100 may include or cooperate with any number of content sources 102; FIG. 1 and this description refer to only one content source 102 for the sake of simplicity. Moreover, a given video services provider (e.g., a satellite video provider, a cable television provider, a telecommunication services provider, or the like) could maintain, provide, or otherwise cooperate with any number of content sources 102 designed to support any number of subscribers.

In certain embodiments, the content source 102 may be deployed as a head end facility and/or a satellite uplink facility for the system 100. In some embodiments, the content source 102 may include or cooperate with one or more web-based content delivery applications, services, or providers. The content source 102 generally functions to control content, signaling data, programming information, and other data sent to any number of receiving components. In practice, the content source 102 may also provide content and data that can be used to populate an interactive electronic program guide (EPG) generated by the authorized subscriber device 104.

The content source 102 includes one or more data processing systems or architectures that are capable of producing signals that are transmitted to customer premise equipment, mobile devices, computer systems, or the like. In various embodiments, the content source 102 represents a satellite, cable, or other content distribution center having: a data control system for controlling content, signaling information, blackout information, programming information, and other data; and a control system for transmitting content, signaling information, blackout information, programming information, and other data using high-bandwidth links. These systems may be geographically, physically and/or logically arranged in any manner, with data control and uplink control being combined or separated as desired.

The authorized subscriber device 104 is any system, component, or piece of hardware that is suitably configured to obtain source content (e.g., video content) for presentation to an authorized user having legitimate permissions, subscription rights, and/or approval to “consume” the source content. In a typical scenario, the subscriber device 104 is owned, operated by, leased by, or otherwise accessed by the subscriber/user as needed for playback of protected source content, which may not be openly available for non-subscriber users.

In accordance with certain embodiments, the authorized subscriber device 104 is a video services receiver (e.g., a customer's set-top box). In this regard, a video services receiver can be realized as any device, system or logic capable of receiving signals from the content source 102. Accordingly, a video services device may include a receiver interface to receive data associated with video services, including any number of video events that are provided by various video providers. In accordance with certain embodiments, the receiver interface may also be utilized to access and receive web-based streaming media content. In this regard, the video services receiver may include or cooperate with a web browser application that provides access to various Internet-based services and resources, including social media applications, streaming media websites, audio/video content providers, and the like.

To support traditional video delivery functions, the authorized subscriber device 104 is capable of providing demodulated content to a customer via an associated display (not shown) that is connected or otherwise linked to the subscriber device 104. Accordingly, the authorized subscriber device 104 may include a suitable display interface for the display, where the display interface facilitates presentation of video and image content on the display. The display may be realized as any of the following, without limitation: a television set; a monitor; a computer display; or any suitable customer appliance with compatible display capabilities. In various embodiments, the authorized subscriber device 104 is implemented as a set-top box (STB) as commonly used with digital video broadcasting, satellite, or cable television distribution systems. In other embodiments, however, the functionality of a video services receiver may be commonly housed within the display itself. In still other embodiments, the subscriber device 104 is a portable device that may be transportable with or without a display. The subscriber device 104 may also be suitably configured to support broadcast television reception, video game playing, personal video recording and/or other features as desired.

During typical operation, the authorized subscriber device 104 receives programming (broadcast events, on-demand video events, streaming media, purchased content, emergency broadcasts, etc.), signaling information, and/or other data via the network. The subscriber device 104 then demodulates, decompresses, descrambles, and/or otherwise processes the received digital data, and then converts the received data to suitably formatted video signals that can be rendered for viewing by the customer on the display. The subscriber device 104 may also be capable of receiving web-based content via the network, the Internet, etc., and may also be capable of recording and playing back video content. In certain scenarios, the subscriber device 104 can be utilized as a playback system for digital media files (e.g., streaming media content) that convey recorded versions of original video program events. Thus, an embodiment of the subscriber device 104 can be configured to download and present video content available on the Internet, and to generate a preview segment from the downloaded video content in the manner described herein.

The subscriber device 104 may include digital video recorder functionality that supports conventional video recording, storage, and playback features. Accordingly, the subscriber device 104 may include or cooperate with flash memory, a hard disk, a removable disk, or any other form of storage medium known in the art that can store recorded video content.

The content management server system 106 can be implemented as a centralized system or as a distributed computing architecture. In practice, the management server system 106 can be implemented as a cloud-based system to provide scalability, efficiency, and reliability. The management server system 106 functions as a central processing component that serves the needs of subscriber devices in the system 100, including the authorized subscriber device 104 shown in FIG. 1. To this end, the management server system 106 can be owned or operated by a video services provider (e.g., a cable television company, a satellite video provider, or a broadcast network) having a customer base that includes authorized subscribers. The management server system 106 is also suitably configured to communicate and interact with any number of non-subscriber devices as needed, including the non-subscriber presentation device 108 shown in FIG. 1. Accordingly, the management server system 106 can support a plurality of different subscriber users and a plurality of different non-subscriber users. The management server system 106 is suitably configured to perform certain processes, methods, and tasks associated with the regulation, handling, and playback control of preview segments of content intended to be shared with non-subscriber presentation devices, as described in more detail below. To this end, the management server system 106 can access, download, or otherwise obtain data that conveys preview segments, wherein the preview segments are generated or provided by authorized subscriber devices 104.

Although not separately depicted in FIG. 1, the authorized subscriber device 104 and/or another component in the system 100 may include video place-shifting functionality, or it may cooperate with a suitably configured place-shifting device or component to place-shift video content. In this regard, it may be possible to provide live or recorded content to a remote device operated by the user, wherein the authorized subscriber device 104, the content source 102, and/or the content management server system 106 serves as a source of the place-shifted content.

The non-subscriber presentation device 108 can be any suitably configured system, component, device, or piece of hardware that is capable of receiving and presenting preview segments that have been shared by authorized subscriber devices 104. In practice, the non-subscriber presentation device 108 may be realized using any compatible platform, including, without limitation: a desktop computer; a laptop computer; a tablet computer; a smart television device; a video game console; home entertainment equipment; a smartphone; a digital media player; a handheld navigation device; a portable medical device; a smart wristwatch or other wearable computing device; or the like. Any number of non-subscriber presentation devices 108 can be supported by the content management server system 106 for purposes of regulating and controlling shared preview segments.

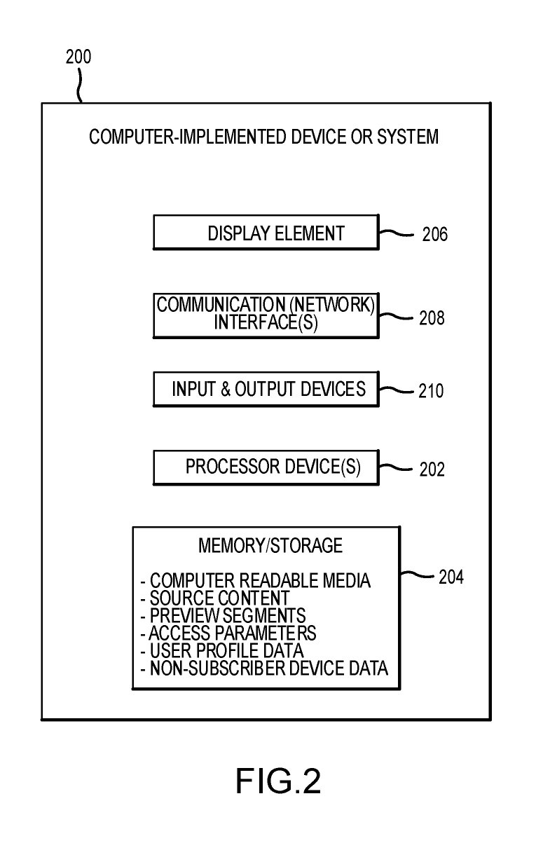

The content source 102, the authorized subscriber device 104, the content management server system 106, and the non-subscriber presentation device 108 can be realized as (or can be integrated with) a computer-implemented component. In this regard, FIG. 2 is a simplified block diagram representation of an exemplary embodiment of a computer-implemented system or device 200 that can be used as any of the elements of the described system 100. The illustrated embodiment of the device 200 generally includes, without limitation: at least one processor device 202; at least one memory/storage device 204; a display element 206; at least one communication (network) interface 208; and input and output (I/O) devices 210. In practice, the device 200 can include additional components, elements, and functionality that may be conventional in nature or unrelated to the particular content sharing and media playback functionality described here.

A processor device 202 may be, for example, a central processing unit (CPU), a field programmable gate array (FPGA), a microcontroller, an application specific integrated circuit (ASIC), or any other logic device or combination thereof. The memory/storage device 204 is communicatively coupled to the processor device 202, and it can be implemented with any combination of volatile and non-volatile memory. The memory/storage device 204 has non-transitory computer readable and executable instructions (program code) stored thereon, wherein the instructions are configurable to be executed by the processor device 202 as needed. When executed by the processor device 202, the instructions cause the processor device 202 to perform the associated tasks, processes, and operations defined by the instructions. Of course, the memory/storage device 204 may also include instructions associated with a file system of the host device 200 and instructions associated with other applications or programs. Moreover, the memory/storage device 204 can serve as a data storage unit for the host device 200. For example, the memory/storage device 204 can provide storage for: source content; preview segments; access parameters that control the manner in which non-subscriber devices and/or unauthorized users access preview segments; user profile data; device data, including data associated with non-subscriber devices; etc.

The display element 206 may be integrated with the device 200 or communicatively coupled to the device 200 as a peripheral or accessory component. The shape, size, resolution, and technology of the display element 206 is appropriate to the particular implementation of the device 200. In certain embodiments, the display element 206 is realized as a touchscreen.

The communication interface 208 represents the hardware, software, and processing logic that enables the device 200 to support data communication with other devices. In practice, the communication interface 208 can be suitably configured to support wireless and/or wired data communication protocols as appropriate to the particular embodiment. For example, if the device 200 is a smartphone, then the communication interface 208 can be designed to support a cellular communication protocol, a short-range wireless protocol (such as the BLUETOOTH communication protocol), and a WLAN protocol. As another example, if the device 200 is a desktop or laptop computer, then the communication interface can be designed to support the BLUETOOTH communication protocol, a WLAN protocol, and a LAN communication protocol (e.g., Ethernet).

The I/O devices 210 enable the user of the device 200 to interact with the device 200 as needed. In practice, the I/O devices 210 may include, without limitation: a speaker, an audio transducer, or other audio feedback component; a haptic feedback device; a microphone; a mouse or other pointing device; a touchscreen or touchpad device; a keyboard; a joystick; or any conventional peripheral device. In this context, a touchscreen display can be categorized as an I/O device 210.

This description assumes that an electronic device of the type described above can be operated to present media content to a user. The source, format, and resolution of the media content are unimportant for purposes of this description. Indeed, the data that conveys the media content can be locally stored at the electronic device, or it can be provided in a streaming media format from a content source, a service provider, a cloud-based entity, or the like. The following description assumes that authorized subscriber devices 104 and non-subscriber presentation devices 108 can successfully and compatibly process, render, and display the desired media (video) content in an appropriate manner.

Referring again to FIG. 1, the content source 102 may be considered to be the original source of video content, such as a video provider, a broadcast network, or the like. The authorized subscriber device 104 is a hardware component that has legitimate access to video content provided by the content source 102. Accordingly, the authorized subscriber device 104 can be a set-top box, a streaming media device, a smart television system, or a networked entertainment system that is owned by a subscriber to a video services provider (e.g., a cable television company, a satellite video provider, etc.). The content management server system 106 is preferably implemented as a backend server that obtains uploaded video preview clips generated by the authorized subscriber device 104. The management server system 106 also manages and regulates access to uploaded preview segments. Non-subscriber presentation devices 108 are devices that are owned or operated by other end users, where those end users are not usually authorized or permitted to view or access the original video content from which the preview segments are generated.

The system 100 presented here allows an authenticated user to create a preview clip from a video program to which the user has legitimate access, and to share the preview clip with someone who does not already have access to the original video program. The authenticated subscriber controls the operation of the authorized subscriber device 104 to create the desired preview segment from the source content, which can be uploaded from the authorized subscriber device 104 to the content management server system 106. The preview segment need not be a continuous portion of the original content—in some scenarios, the preview segment can be pieced together from any number of continuous sub-segments of the original content. Moreover, the preview segment can include sub-segments taken from different source content items. The authorized subscriber device 104 creates the preview clip from the video data obtained from the content source 102, and reformats, encodes, or otherwise processes the preview clip data to make it suitable for uploading. In practice, the preview clip can be formatted into a streaming video file, such as an MP4 file.

The content management server system 106 maintains parameters, restrictions, and control information that govern the manner in which uploaded video clips can be accessed by non-subscriber users. For example, the management server system 106 can maintain a table that includes device identifiers for presentation devices and/or user profile data for end users, along with corresponding access restrictions, parameters, and other criteria stored in association with each device identifier and user profile.

The content management server system 106 controls access to preview clips using one or more parameters, e.g., access criteria, restrictions, limits, or the like. These parameters include, without limitation: a maximum time length for each preview clip; the maximum number of times a preview clip can be generated on a particular channel or for a particular program; a time duration for viewing access of a preview clip; the number of times an unauthenticated viewer or non-subscriber user can watch a preview clip; the number of different unauthenticated viewers that are allowed to access a preview clip; and a list of approved non-subscriber presentation devices and/or a list of prohibited non-subscriber devices.

One primary focus of this concept relates to the creation, sharing, and management of preview clips that are generated from an authorized, legitimate, authenticated device (e.g., an authorized and authenticated set-top box issued to a customer). The manner in which the content management server system 106 controls access to each preview clip is also a notable aspect of the disclosed subject matter—these controls make the system acceptable to video service providers and video content creators who might otherwise be worried about free and widespread distribution of copyrighted content.

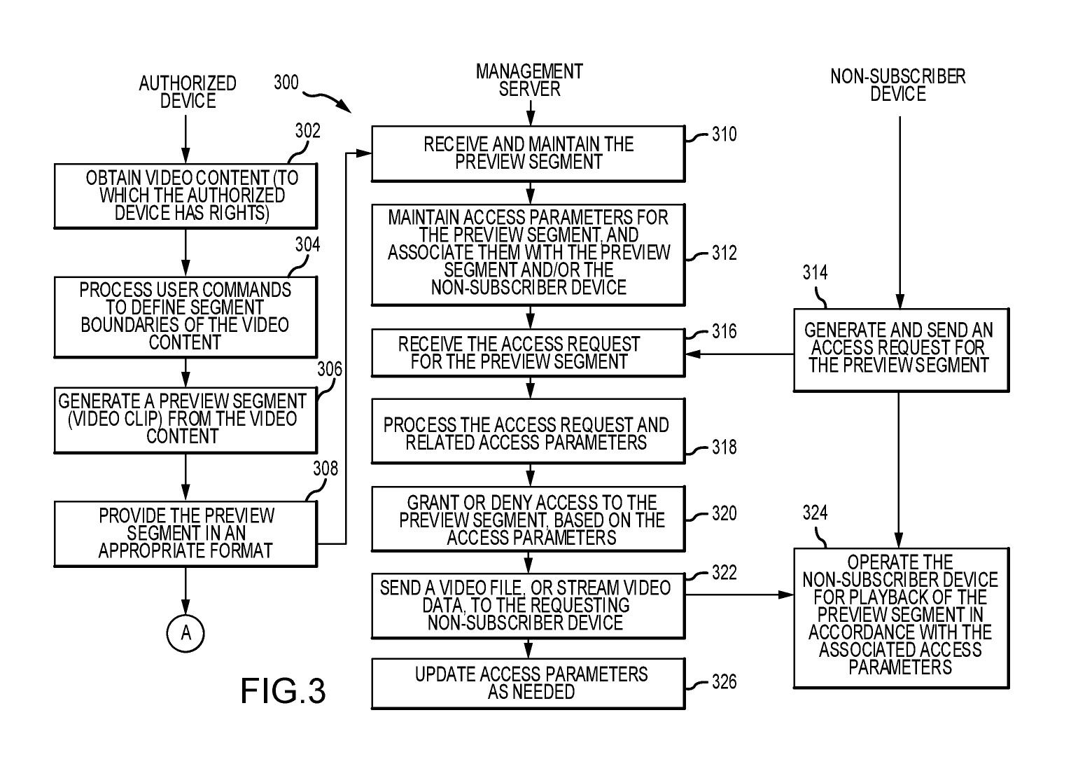

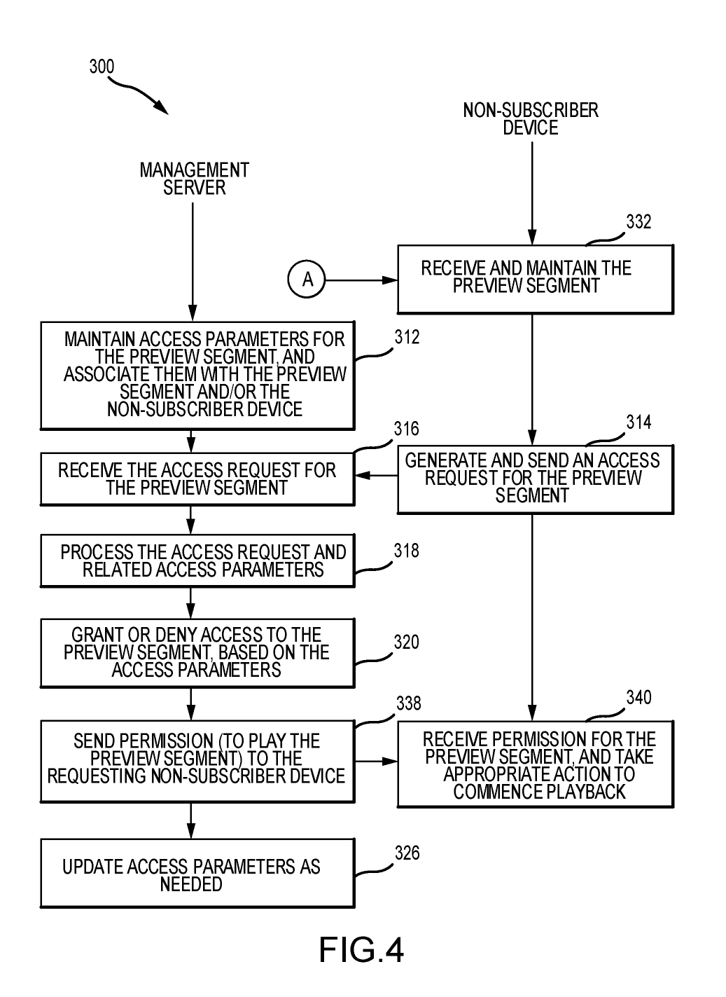

FIG. 3 is a flow chart that illustrates an exemplary embodiment of a process 300 of managing preview segments of content to be shared with non-subscriber presentation devices, and FIG. 4 is a flow chart that illustrates an alternate embodiment of the process 300. The various tasks performed in connection with the process 300 may be performed by software, hardware, firmware, or any combination thereof. For illustrative purposes, the following description of the process 300 may refer to elements mentioned above in connection with FIGS. 1 and 2. In practice, portions of the process 300 may be performed by different elements of the described system, e.g., a subscriber device, the management server system, or a presentation device. It should be appreciated that process 300 may include any number of additional or alternative tasks, the tasks shown in FIGS. 3 and 4 need not be performed in the illustrated order, and the process 300 may be incorporated into a more comprehensive procedure or process having additional functionality not described in detail herein. Moreover, one or more of the tasks shown in the figures could be omitted from an embodiment of the process 300 as long as the intended overall functionality remains intact.

The illustrated embodiment of the process 300 involves at least three components: an authorized device; a management server; and a non-subscriber device (as described above). To this end, FIGS. 3 and 4 depict certain tasks performed by each of the components. Tasks performed by the authorized device are aligned to the left, tasks performed by the non-subscriber device are aligned to the right, and tasks performed by the management server are centered.

The process 300 begins by obtaining video content at the authorized subscriber device (task 302). This description assumes that the authorized subscriber device has legitimate rights and permission to receive, play, and store the video content, and has legitimate rights and permission to create preview segments from the video content. The process 300 continues by controlling the operation of the authorized subscriber device to generate a preview segment from the obtained content. For this example, the source content includes video content and, therefore, the preview segment includes a video clip generated from the video content. In practice, a user of the authorized subscriber device can initiate certain commands (which are processed and executed by the subscriber device) to define segment boundaries of the source video content. The segment boundaries correspond to the start and end of the preview segment. Thus, the user commands are processed to define the segment boundaries of the source video content (task 304) and the authorized subscriber device generates the corresponding preview segment (a video clip in this example) from the video content (task 306). The authorized subscriber device communicates, sends, or otherwise provides the generated preview segment in an appropriate format (task 308).

This description assumes that the management server system successfully receives and maintains the generated preview segment in a suitable manner (task 310). The management server system is configured and operated to maintain any number of preview segments generated from source content available at any number of different authorized subscriber devices. Accordingly, the management server system can leverage conventional database management technology if so desired to store and maintain preview segments in association with related information, metadata, and the like (task 312). For example, the management server system maintains access parameters for each preview segment (if restrictions are necessary or desired). Access parameters can be associated with preview segments, non-subscriber devices, the originating authorized subscriber devices, originating subscriber users, non-subscriber users, etc.

The access parameters for a preview segment are intended to regulate, control, manage, and/or restrict access to the preview segment by non-subscriber presentation devices (normally having restricted rights to directly view or access the source content). Some or all of the access parameters for a preview segment can be reviewed or checked in response to an access request by a non-subscriber presentation device or a non-subscriber user, wherein access is granted or denied based on the current status, state, values, or properties of the corresponding access parameters. In accordance with certain embodiments, the process 300 associates at least one of the following access parameters with the preview segment: a maximum number of times the preview segment can be accessed; a designated period of time during which the preview segment is accessible to non-subscriber presentation devices; a designated time at which the preview segment is rendered inaccessible to non-subscriber presentation devices; a maximum number of times the requesting non-subscriber presentation device can access the preview segment; a maximum number of times the user of the requesting non-subscriber presentation device can access the preview segment; a maximum number of different non-subscriber presentations devices allowed to access the preview segment; a maximum number of users of non-subscriber presentation devices allowed to access the preview segment; a list of approved non-subscriber presentation devices; a list of prohibited non-subscriber presentation devices; a list of approved users of non-subscriber presentation devices; a list of prohibited users of non-subscriber presentation devices; a limit on quality parameters (e.g., resolution) of the preview segment; a limit on the geographical locations of the non-subscriber device at which the preview segment is available; parental control restrictions based on ratings of the preview segment; a limit on the number of preview segments that can be generated from specified content; and a limit on the duration of the preview segment that can be generated. The foregoing list of access parameters is not exhaustive, and is not intended to limit the scope or applicability of the described subject matter. It should be appreciated that additional or alternative access parameters or control schemes can be utilized or implemented if so desired.

The example shown in FIG. 3 assumes that the non-subscriber presentation device generates and sends an access request for the preview segment (task 314) and that the management server system successfully receives the access request (task 316). The access request can be generated in response to selection of a link or an active user interface element rendered at the non-subscriber presentation device, or in response to any selection action or operation supported by the non-subscriber presentation device, wherein the selection action identifies the preview segment of interest. In certain embodiments, The access request includes a preview identifier of the preview segment and at least one of the following, without limitation: a device identifier of the requesting non-subscriber presentation device; a user identifier of a user of the requesting non-subscriber presentation device; and a network address of the requesting non-subscriber presentation device. The management server system processes the access request in an appropriate manner to determine or identify the access parameters for the preview segment, wherein the access parameters are applicable to the requesting non-subscriber presentation device (task 318). In this regard, the management server system reviews the information conveyed in the access request, identifies the requested preview segment using the preview identifier, and reviews any access parameters associated with the preview identifier, the requesting user identifier, the device identifier, and/or the network address of the requesting presentation device.

The management server system grants or denies the requesting non-subscriber presentation device access to the preview segment, based on the applicable access parameters (task 320). This example assumes that access is granted. Accordingly, the preview segment is sent, streamed, downloaded, emailed, or otherwise provided to the requesting non-subscriber presentation device (task 322). In certain scenarios, the management server system sends a video file to the requesting non-subscriber presentation device, wherein the video file conveys the preview segment and is formatted for playback at the requesting non-subscriber presentation device. The video file can be generated by the management server system, or it can originate elsewhere (e.g., the authorized subscriber device) for storage at the management server system. In accordance with another scenario, the management server system streams video data to the requesting non-subscriber presentation device, wherein the streaming video data conveys the preview segment and is formatted for streaming playback at the requesting non-subscriber presentation device.

This example assumes that the non-subscriber presentation device successfully receives the preview segment. Accordingly, the presentation device is operated in an appropriate manner (preferably using its native features, functionality, and application set) for playback of the preview segment (task 324). Notably, playback of the preview segment may still be governed by one or more of the defined access parameters. Thus, playback of the preview segment at the presentation device may be performed in accordance with the associated access parameters, if so desired.

In certain embodiments, the management server system updates the access parameters for the preview segment, if necessary to account for current or recent playback activity (task 326). For example, if the access parameters dictate that the preview segment can only be played back at three different non-subscriber presentation devices, then the management server system can maintain a simple counter that is reduced whenever access is granted to the preview segment. As another example, if the access parameters include an “expiration date” for the preview segment, then the management server system can prohibit access to the preview segment (e.g., delete it, deactivate access links, or the like) after the expiration data passes.

The example shown in FIG. 3 assumes that the preview segment is maintained at the management server system. In contrast, the example shown in FIG. 4 assumes that the authorized subscriber device provides the preview segment to the non-subscriber presentation device. The circle labeled “A” in FIG. 3 and FIG. 4 represents the process flow for this embodiment—task 308 provides the preview segment, and the non-subscriber presentation device receives and locally maintains the preview segment (task 332 depicted in FIG. 4).

Even though the preview segment is stored at the non-subscriber presentation device, the process 300 controls and regulates playback access by way of the management server system. In this regard, the embodiment depicted in FIG. 4 also performs tasks 314, 316, 318, and 320, which were described previously with reference to FIG. 3. This example assumes that the management server system grants playback access to the preview segment. In certain embodiments, the management server system sends, grants, or otherwise issues permission to the requesting non-subscriber presentation device (task 338), to allow the non-subscriber presentation device to play or otherwise access the preview segment. This description assumes that the presentation device successfully receives and processes the permission for the preview segment (task 340). Accordingly, the presentation device is operated in an appropriate manner (preferably using its native features, functionality, and application set), and takes appropriate action to commence playback of the preview segment (task 340). For this example, a suitably formatted video file resident at the presentation device is played. In other scenarios, the preview segment maintained at the presentation device may be incomplete, low resolution, or merely a pointer to a file or content that must be downloaded or streamed after obtaining permission. These and other mechanisms are contemplated by this disclosure.

Notably, playback of the preview segment may still be governed by one or more of the defined access parameters. Thus, playback of the preview segment at the presentation device may be performed in accordance with the associated access parameters, if so desired. As mentioned above with reference to FIG. 3, the management server system updates the access parameters for the preview segment, if necessary to account for current or recent playback activity (task 326).

Local Access Control

The exemplary embodiment described above utilizes the management server system to regulate and control access to the preview segments. Alternatively or additionally, the methodology described here can employ an access control mechanism that relies on access parameters embedded in the preview segment data, wherein the embedded access parameters are locally processed by the non-subscriber presentation devices. For example, a preview segment can be suitably formatted and provided to the presentation device with access-related metadata conveyed therewith. Upon receipt at the presentation device, the metadata is reviewed and used to determine the access rights and permissions for the preview segment. This type of local access control need not rely on a centralized management server system to regulate playback access by non-subscriber presentation devices.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method of managing preview segments of content to be shared with non-subscriber presentation devices of a computer-implemented video services system, the method comprising the steps of:
maintaining, at a computer-implemented management server system, a preview segment generated from source content available at a computer-implemented authorized subscriber device;
associating the preview segment with access parameters maintained in a memory device of the management server system, the access parameters regulating and restricting access to the preview segment by computer-implemented non-subscriber presentation devices having restricted rights to directly view or access the source content;
receiving, at the management server system, an access request generated by a requesting non-subscriber presentation device, the access request comprising a preview identifier of the preview segment and at least one of: a device identifier of the requesting non-subscriber presentation device, a user identifier of a user of the requesting non-subscriber presentation device, and a network address of the requesting non-subscriber presentation device, wherein the access request is received via a data communication network;
processing the access request at the management server system to determine access parameters for the preview segment applicable to the requesting non-subscriber presentation device;
granting or denying the requesting non-subscriber presentation device access to the preview segment, based on the determined access parameters; and
sending a video file from the management server system to the requesting non-subscriber presentation device via the data communication network, the video file conveying the preview segment formatted for playback at the requesting non-subscriber presentation device, and the video file conveying access-related metadata for local processing by the non-subscriber presentation device, the access-related metadata indicating access rights and permissions for the preview segment.

2. The method of claim 1, wherein the authorized subscriber device is a video services receiver.

3. The method of claim 2, wherein the source content comprises video content, and the preview segment comprises a video clip generated from the video content.

4. The method of claim 3, further comprising:
controlling operation of the authorized subscriber device to generate the video clip from the video content.

5. The method of claim 1, wherein the associating step associates at least one of the following access parameters with the preview segment: a maximum number of times the preview segment can be accessed; a designated period of time during which the preview segment is accessible to non-subscriber presentation devices; a designated time at which the preview segment is rendered inaccessible to non-subscriber presentation devices; a maximum number of times the requesting non-subscriber presentation device can access the preview segment; a maximum number of times the user of the requesting non-subscriber presentation device can access the preview segment; a maximum number of different non-subscriber presentations devices allowed to access the preview segment; a maximum number of users of non-subscriber presentation devices allowed to access the preview segment; a list of approved non-subscriber presentation devices; a list of prohibited non-subscriber presentation devices; a list of approved users of non-subscriber presentation devices; a list of prohibited users of non-subscriber presentation devices; a limit on quality parameters of the preview segment; a limit on the geographical locations of the non-subscriber device at which the preview segment is available; parental control restrictions based on ratings of the preview segment; a limit on the number of preview segments that can be generated from specified content; and a limit on the duration of the preview segment that can be generated.

6. (canceled)

7. (canceled)

8. The method of claim 1, wherein:
the source content comprises video content; and
the method further comprises the step of processing commands initiated from the authorized subscriber device to define segment boundaries of the video content, the segment boundaries corresponding to the preview segment.

9. A computer-implemented content management server system comprising:
a processor device; and
a non-transitory computer readable medium operatively associated with the processor device, the computer readable medium comprising executable instructions configurable to cause the processor device to perform a method of managing preview segments of content to be shared with computer-implemented presentation devices, the method comprising the steps of:
maintaining, at the content management server system, a preview segment generated from source content available at a computer-implemented authorized subscriber device;
associating the preview segment with access parameters maintained in a memory device of the content management server system, the access parameters regulating and restricting access to the preview segment by computer-implemented non-subscriber presentation devices having restricted rights to directly view or access the source content;
receiving, at the content management server system, an access request generated by a requesting non-subscriber presentation device, the access request comprising a preview identifier of the preview segment and at least one of: a device identifier of the requesting non-subscriber presentation device, a user identifier of a user of the requesting non-subscriber presentation device, and a network address of the requesting non-subscriber presentation device, wherein the access request is received via a data communication network;
processing the access request at the content management server system to determine access parameters for the preview segment applicable to the requesting non-subscriber presentation device;
granting or denying the requesting non-subscriber presentation device access to the preview segment, based on the determined access parameters; and
sending a video file from the management server system to the requesting non-subscriber presentation device via the data communication network, the video file conveying the preview segment formatted for playback at the requesting non-subscriber presentation device, and the video file conveying access-related metadata for local processing by the non-subscriber presentation device, the access-related metadata indicating access rights and permissions for the preview segment.

10. The system of claim 9, wherein the source content comprises video content, and the preview segment comprises a video clip generated from the video content.

11. The system of claim 9, wherein at least one of the following access parameters is associated with the preview segment: a maximum number of times the preview segment can be accessed; a designated period of time during which the preview segment is accessible to non-subscriber presentation devices; a designated time at which the preview segment is rendered inaccessible to non-subscriber presentation devices; a maximum number of times the requesting non-subscriber presentation device can access the preview segment; a maximum number of times the user of the requesting non-subscriber presentation device can access the preview segment; a maximum number of different non-subscriber presentations devices allowed to access the preview segment; a maximum number of users of non-subscriber presentation devices allowed to access the preview segment; a list of approved non-subscriber presentation devices; a list of prohibited non-subscriber presentation devices; a list of approved users of non-subscriber presentation devices; a list of prohibited users of non-subscriber presentation devices; a limit on quality parameters of the preview segment; a limit on the geographical locations of the non-subscriber device at which the preview segment is available; parental control restrictions based on ratings of the preview segment; a limit on the number of preview segments that can be generated from specified content; and a limit on the duration of the preview segment that can be generated.

12. (canceled)

13. (canceled)

14. A method of managing preview segments of content to be shared with non-subscriber presentation devices of a computer-implemented video services system, the method comprising the steps of:
maintaining, at a computer-implemented management server system, access parameters in association with a preview segment generated from source content available at to regulate and restrict access to the preview segment by computer-implemented non-subscriber presentation devices having limited rights to directly view or access the source content;
receiving, at the management server system, an access request generated by a requesting non-subscriber presentation device, the access request comprising a preview identifier of the preview segment and at least one of: a device identifier of the requesting non-subscriber presentation device, a user identifier of a user of the requesting non-subscriber presentation device, and a network address of the requesting non-subscriber presentation device, wherein the access request is received via a data communication network;
processing the access request at the management server system to determine access parameters for the preview segment applicable to the requesting non-subscriber presentation device;
granting or denying the requesting non-subscriber presentation device access to the preview segment, based on the determined access parameters; and
sending a video file from the management server system to the requesting non-subscriber presentation device via the data communication network, the video file conveying the preview segment formatted for playback at the requesting non-subscriber presentation device, and the video file conveying access-related metadata for local processing by the non-subscriber presentation device, the access-related metadata indicating access rights and permissions for the preview segment.

15. The method of claim 14, wherein the source content comprises video content, and the preview segment comprises a video clip generated from the video content.

16. The method of claim 14, wherein at least one of the following access parameters is associated with the preview segment: a maximum number of times the preview segment can be accessed; a designated period of time during which the preview segment is accessible to non-subscriber presentation devices; a designated time at which the preview segment is rendered inaccessible to non-subscriber presentation devices; a maximum number of times the requesting non-subscriber presentation device can access the preview segment; a maximum number of times the user of the requesting non-subscriber presentation device can access the preview segment; a maximum number of different non-subscriber presentations devices allowed to access the preview segment; a maximum number of users of non-subscriber presentation devices allowed to access the preview segment; a list of approved non-subscriber presentation devices; a list of prohibited non-subscriber presentation devices; a list of approved users of non-subscriber presentation devices; a list of prohibited users of non-subscriber presentation devices; a limit on quality parameters of the preview segment; a limit on the geographical locations of the non-subscriber device at which the preview segment is available; parental control restrictions based on ratings of the preview segment; a limit on the number of preview segments that can be generated from specified content; and a limit on the duration of the preview segment that can be generated.

17. The method of claim 14, wherein:
the source content comprises video content; and
the method further comprises the step of processing commands initiated from the authorized subscriber device to define segment boundaries of the video content, the segment boundaries corresponding to the preview segment.

18. (canceled)

19. (canceled)
